(19) United States
(12) Patent Application Publication
(10) Pub. No.: US 2016/0018992 A1
(43) Pub. Date: Jan. 21, 2016

(54) STORAGE CONTROL DEVICE, AND STORAGE SYSTEM

(71) Applicant: FUJITSU LIMITED, Kawasaki-shi (JP)

(72) Inventors: Tatsushi TAKAMURA, Sagamihara (JP); Tsuyoshi UCHIDA, Kawasaki (JP)

(21) Appl. No.: 14/735,177

(22) Filed: Jun. 10, 2015

(30) Foreign Application Priority Data
Jul. 17, 2014 (JP) 2014-147188

(51) Int. Cl. G06F 3/06

(52) U.S. Cl. CPC G06F 3/0604; G06F 3/0647; G06F 3/0683

(57) ABSTRACT

A storage control device includes a processor that executes a process. The process includes conducting, on the basis of information related to distributed arrangement in a case when first divisional data obtained by dividing first data has been arranged distributedly in a first storage and in at least one different storage different from the first storage, control of relocating the first divisional data to the first storage from the different storage, and conducting control of moving the first data stored in the first storage from the first storage to a second storage after moving a control unit from the first storage to the second storage, the control unit being configured to conduct input or output control of the first data.

### CROSS-REFERENCE TO RELATED APPLICATION

This application is based upon and claims the benefit of priority of the prior Japanese Patent Application No. 2014-147188, filed on Jul. 17, 2014, the entire contents of which are incorporated herein by reference.

### FIELD

The embodiments discussed herein are related to a storage control device, a storage system, and a storage control program.

### BACKGROUND

As a technique that links a plurality of storages so as to make them operate as one system, a technique referred to as scale-out storage is known. A technique referred to as wide striping is also known, which distributes segments of a volume to a plurality of storages in order to suppress the concentration of input/output loads.

According to scale-out storage, when the capacity or the performance has become insufficient, a storage (also referred to as a node hereinafter) is replaced. There is also a case where an operating storage whose support period has become close to the expiration is replaced with a new storage. As related techniques, the following three techniques are proposed (for example, Patent Documents 1 through 3).

In the first technique, the storage system is connected to a name server that manages the correspondence relationship between the initiator and targets. The storage system includes a first storage node and a second storage node. In the first storage node, a first logical unit in which a first target is set exists while a second logical unit in which a second target is set exists in the second storage node. When data is moved to the second logical unit from the first logical unit, the first storage node transmits information of the first target to the second storage node as well as data stored in the first logical unit. The second storage node utilizes the received information of the first target so as to set a target in the second logical unit.

The second technique starts the operation of moving a logical volume from a first storage location to a second storage location. In order to copy data in the logical volume from the first storage location to the second storage location, one relationship is established between the first and second storage locations. While data in the logical volume is copied from the first storage location to the second storage location, a read request for the data in the logical volume is received. In response to the read request, whether the requested data is in the first copy of the logical volume at the first storage location or in the second copy of the logical volume at the second storage location is determined. The requested data is returned from the determined first or second copy of the logical volume while the logical volume is copied from the first storage location to the second storage location.

The third technique is a technique related to a system in which a first storage device, a second storage device, and a computation device are connected via a network. The first storage device manages a target to which a first physical port and a first logical volume have been assigned. The second storage device manages a second logical volume. The computation device establishes a first communication channel with the first physical port and accesses the target by using this communication channel. The first storage device generates a target having the same identifier as does the target in the second storage device, and assigns the second logical volume and the second physical port to that target. The computation device establishes a second communication channel with the second physical port, and continues the access to the target by using the second communication channel.

The techniques described in the following documents are known.

Patent Document 1: Japanese Laid-open Patent Publication No. 2005-353035

Patent Document 2: Japanese Laid-open Patent Publication No. 2008-009978

Patent Document 3: Japanese Laid-open Patent Publication No. 2006-092054

### SUMMARY

According to an aspect of the embodiment, a storage control device includes a processor that executes a process. The process includes conducting, on the basis of information related to distributed arrangement in a case when first divisional data obtained by dividing first data has been arranged distributedly in a first storage and in at least one different storage different from the first storage, control of relocating the first divisional data to the first storage from the different storage, and conducting control of moving the first data stored in the first storage from the first storage to a second storage after moving a control unit from the first storage to the second storage, the control unit being configured to conduct input or output control of the first data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of scale-out storage;

FIG. 2 illustrates an example of a state in which segments received wide striping so as to be distributed to a plurality of storages;

FIG. 3 illustrates an example of a system to which a new node has been added;

FIG. 4 explains an example of the concept of wide striping;

FIG. 5 illustrates an example of a first table;

FIG. 6 illustrates an example of a second table;

FIG. 7 illustrates an example of functional blocks of a metabolism manager;

FIGS. 8A and 8B illustrate examples of volume relocation;

FIG. 9 illustrates an example of the entire system in a state after relocation of segments was conducted;

FIG. 10 illustrates an example of moving an input/output control unit to a new node;

FIG. 11 explains an example of volume movement and access from a server to a new node;

FIG. 12 explains an example of a case when a new node does not have compatibility with an interconnect;

FIG. 13 illustrates an example of a state of a system in which a replacement node has been separated from the system;

FIG. 14 illustrates an example of a state of a system in which wide striping was conducted in the state illustrated in FIG. 13;

FIG. 15 explains an example of access from a server in a case when a new node does not have compatibility with an interconnect;

FIG. 16 illustrates an example of respective nodes in a case when a plurality of nodes have been replaced;

FIG. 17 illustrates an example of respective nodes in a case when wide striping was conducted in the state illustrated in FIG. 16;

FIG. 18 illustrates a flowchart representing a first selection process (first);

FIG. 19 illustrates a flowchart representing the first selection process (second);

FIG. 20 illustrates a flowchart representing a second selection process;

FIG. 21 illustrates a flowchart representing a relocation control process;

FIG. 22 illustrates a flowchart representing a movement control process (first);

FIG. 23 illustrates a flowchart representing the movement control process (second); and

FIG. 24 illustrates an example of a hardware configuration of a controller of a new node.

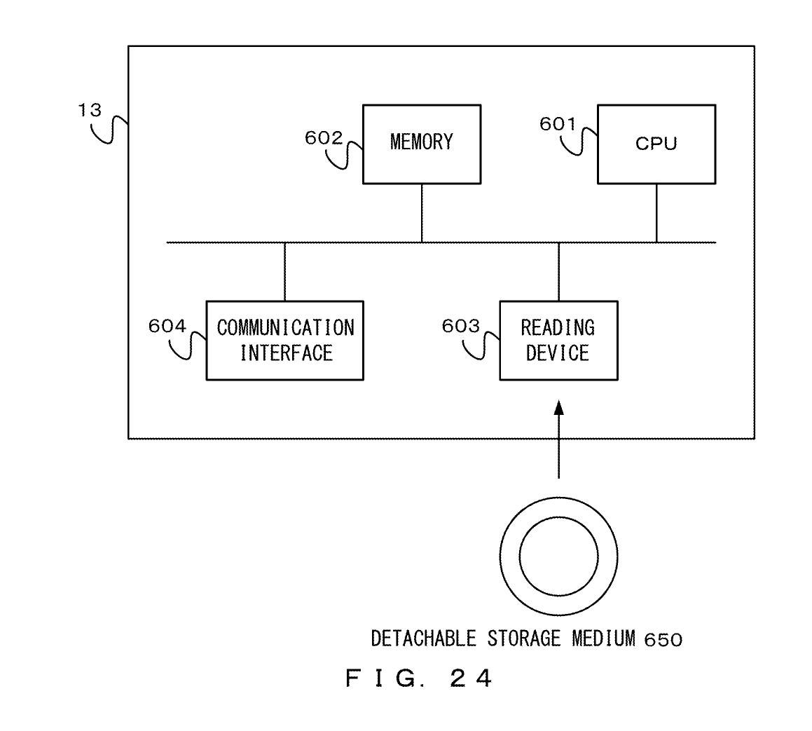

### DESCRIPTION OF EMBODIMENTS

When data is moved from an operating storage to a new storage in a situation in which data has been distributed to a plurality of storages, there is a possibility that data in a movement-target storage will be updated by a storage that is not a movement target. This makes it difficult to move data efficiently. Also, it is desirable to move data while continuing the operation of the system.

A storage control device according to the embodiments can move data efficiently while continuing the operation of the system.

### (Example of Entire Configuration of System)

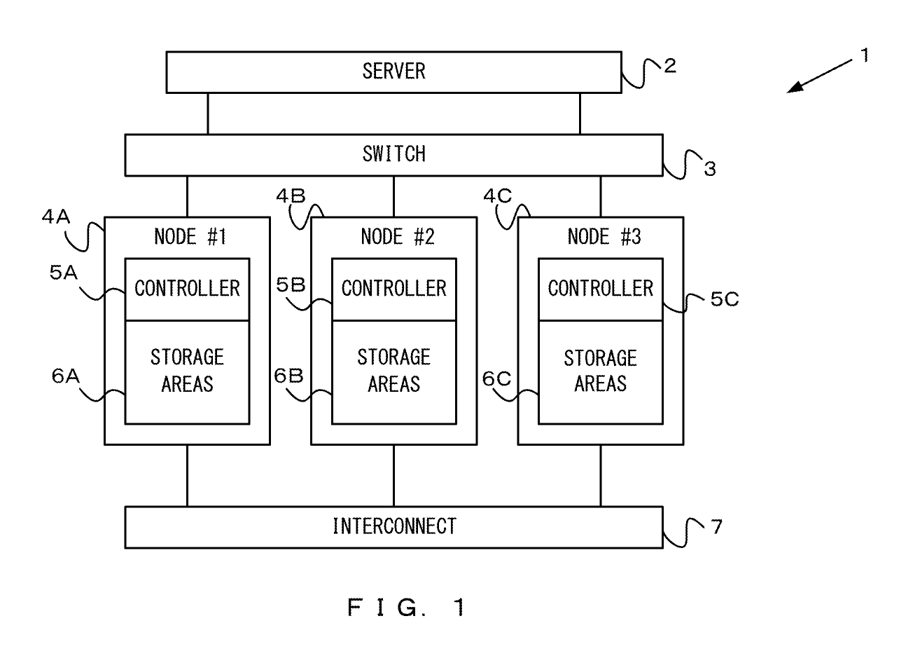

Hereinafter, explanations will be given for the embodiments by referring to the drawings. FIG. 1 illustrates an example of a system 1. The system 1 includes a server 2, a switch 3, nodes 4A through 4C, and an interconnector 7. The system 1 is an example of a storage system.

The server 2 is a host device, and conducts prescribed processes. The server 2 is also referred to as a business server in some cases. The switch 3 switches communications between the server 2 and the nodes 4A through 4C. The switch 3 is also referred to as a business switch in some cases.

In the example illustrated in FIG. 1, nodes 4A through 4C appear as “node #1”, “node #2” and “node #3”, respectively. The respective nodes 4A through 4C are examples of storages. The storages are accommodated in for example storage casings.

The nodes 4A through 4C (which may also be referred to as nodes 4 as a collective term) respectively include controllers 5A through 5C (which may also be referred to as controllers as a collective term) and storage areas 6A through 6C (which may also be referred to as storage areas 6 as a collective term). The controllers 5 and the storage areas 6 are also accommodated in for example the above storage casings.

The storage areas 6 store data. The storage areas 6 are for example disk areas. The controllers 5 conduct control of data stored in the storage areas 6 including reading, writing, etc. The interconnector 7 is a communication channel connecting the respective nodes 4. In the example illustrated in FIG. 1, data stored in each node 4 can be moved to a different node 4 via the switch 3 and the interconnector 7.

### (Example of Wide Striping)

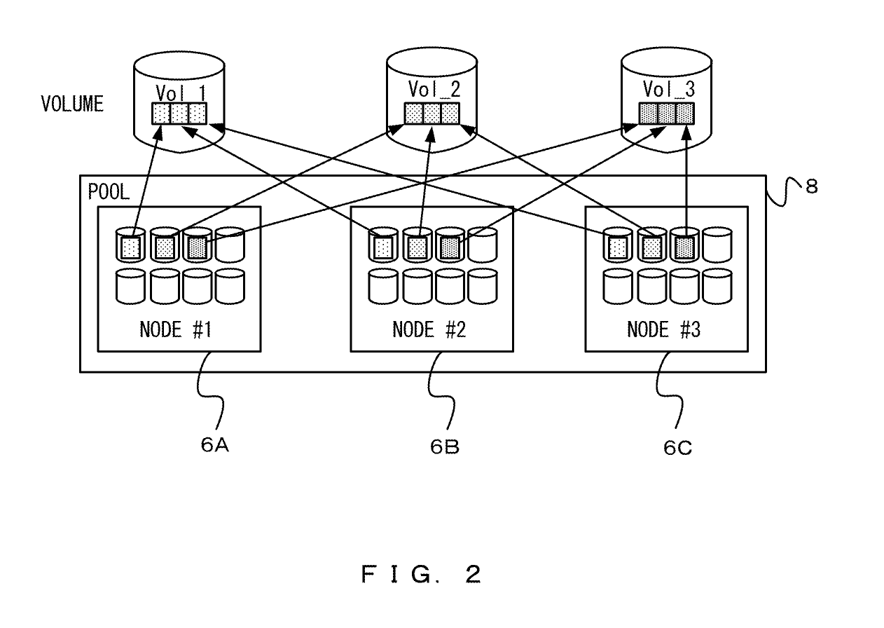

The system 1 illustrated in FIG. 1 employs the configuration of scale-out storage. As illustrated in the example in FIG. 2, scale-out storage manages the storage areas 6 in the respective nodes 4 as a pool 8 in a centralized manner. Accordingly, even when the respective nodes are separated from each other, the users can treat the storage areas 6 in the respective nodes 4 as one virtual storage area.

Each of the nodes 4 manages data in units of volumes. Volumes are also referred to as logical volumes in some cases. Volumes themselves are data and are divided into a plurality of pieces in the embodiments. In the embodiments, pieces of information obtained by the dividing are referred to as segments. Segments are an example of divisional data.

Although explanations will be given in the embodiments by treating data as a volume and by treating divisional data as a segment as described above, data is not limited to volume. Divisional data is not limited to segment either. Data may be arbitrary information and divisional data can be any information that is obtained by dividing data.

The example illustrated in FIG. 2 illustrates a case where the volumes whose input/output are controlled by the nodes 4A through 4C are denoted by “Vol_1”, “Vol_2” and “Vol_3”, respectively.

Segments obtained by dividing the volumes whose input/output are controlled by the respective nodes 4 are arranged distributedly in the storage areas 6 of the respective nodes 4. This distributed arrangement is also referred to as wide striping in some cases. In wide striping, segments are arranged distributedly in the plurality of nodes 4 so that the input/output loads are not concentrated on one of the nodes 4. By conducting wide striping, the system 1 can perform stably.

A volume whose input/output is controlled by the respective nodes 4 is divided into three segments in the example illustrated in FIG. 2. Those three segments are arranged distributedly in the three nodes 4 respectively. This makes it possible to arrange the divisional three segments in a uniformly distributed manner. Volumes may be divided into an arbitrary number of segments. Note that while FIG. 2 illustrates an example in which the storage areas 6 of the respective nodes 4 are included in the same pool 8, the storage areas 6 of some of the nodes 4 may be included in a different pool.

(Example in which a New Node has been Added)

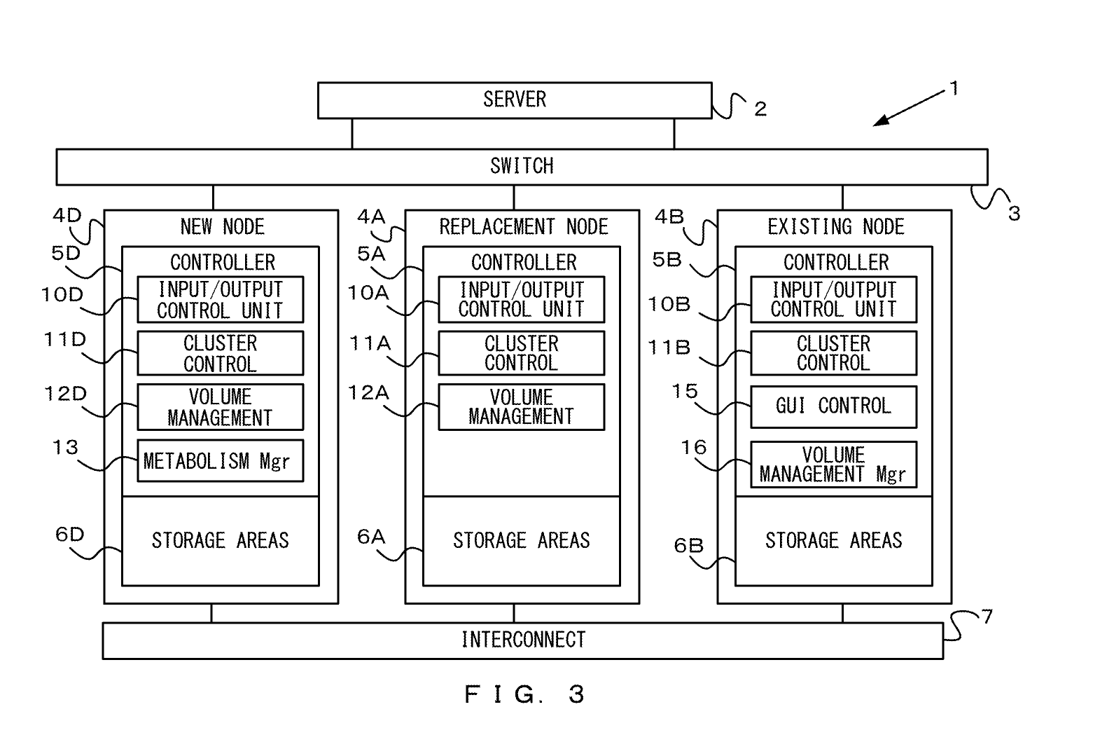

FIG. 3 illustrates an example in which new nodes have been added to the system 1. As illustrated in FIG. 3, there are three types of the nodes 4 in the embodiment. The replacement node 4A is a replacement target node. The replacement node 4A is an example of a first storage.

The existing node 4B is a node that does not become a replacement target among the nodes 4 that were operated in the existing system 1. The existing node 4B is an example of a different storage. In the example of the above wide striping, segments have been arranged distributedly in the replacement node 4A and at least one existing node 4.

The example illustrated in FIG. 3 illustrates a case where there is one existing node 4B, however, for example the node 4C illustrated in FIG. 1 may be an existing node. The number of existing nodes is not limited to one or two. The new node 4D is a node to be added newly. The replacement node 4A is replaced with the new node 4D. The new node 4D is an example of a second storage.

Explanations will be given for the controller 5A of the replacement node 4A. The controller 5A includes an input/output control unit 10A, cluster control 11A, and volume management 12A. The input/output control unit 10A conducts the input/output control of data with respect to the replacement node 4A.

The input/output control unit included in the node 4 that is to be replaced is an example of a control unit. In the example illustrated in FIG. 3, the input/output control unit 10A is an example of the control unit. The cluster control 11A conducts control related to the clustering between the plurality of nodes. In the system 1, some of the plurality of nodes 4 may employ a redundant configuration (cluster configuration). The volume management 12A manages volumes.

Explanations will be given for the controller 5B of the existing node 4B. The controller 5B includes an input/output control unit 10B, cluster control 11B, GUI control 15, and a volume management manager 16. In the drawings, the management manager is referred to as “volume management Mgr”.

The input/output control unit 10B conducts the input/output control of data with respect to the existing node 4B. The cluster control 11B conducts control with respect to the clustering between the plurality of nodes. The GUI control 15 conducts control of the GUI (Graphical User Interface). The volume management manager 16 manages segments arranged distributedly in the replacement node 4A and the existing node 4B.

### (Example of Volume Management Manager)

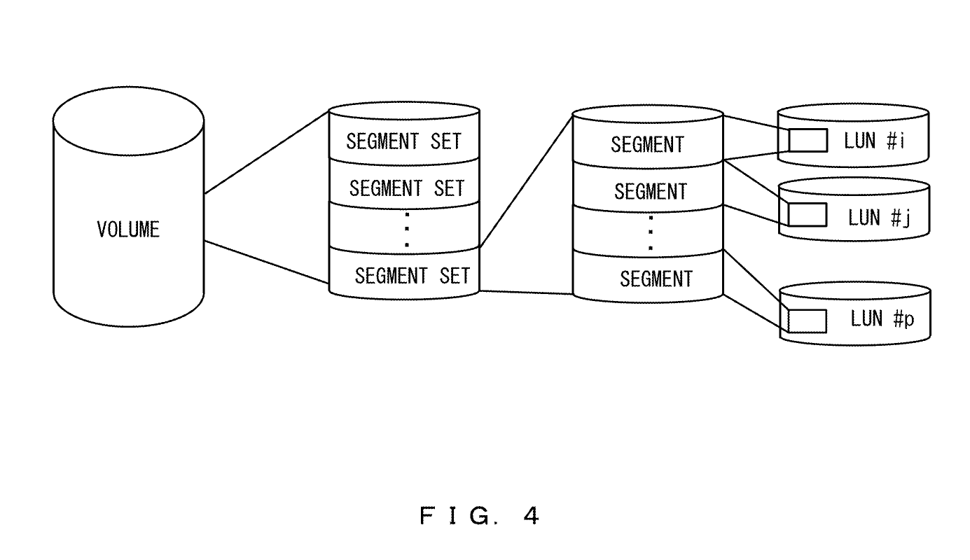

Now, explanations will be given for an example of a volume management manager 17 based on wide striping. FIG. 4 illustrates an example of the concept of wide striping. As illustrated in FIG. 4, a volume is divided into a plurality of segment sets. Also, each of the segment sets is also divided into a plurality of segments. Divisional segments are arranged distributedly in a plurality of LUNs (Logical Unit Numbers). In the embodiments, the LUNs serve as storages.

When for example one segment is of 256 MB in a situation where one volume has been divided into four segment sets and one segment set has been divided into eight segments, one volume is of 8 GB.

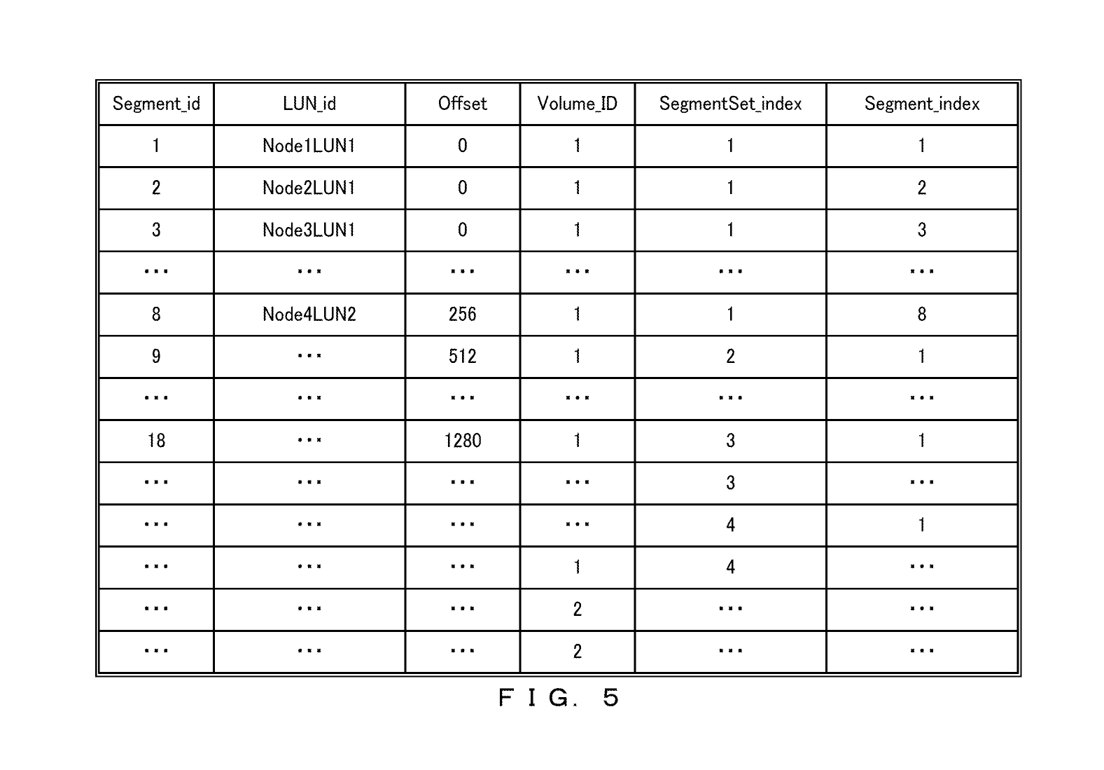

FIG. 5 illustrates an example of a first table managed by the volume management manager 16. “Segment_id” on the first table illustrated in the example of FIG. 5 represents the identification numbers assigned to segments. “LUN_id” represents the identification numbers of LUNs to which the corresponding segments belong. “Offset” represents the offsets in the LUNs.

“Volume_ID” represents the identification numbers of volumes. “SegmentSet_index” represents the indexes of segment sets. “Segment_index” represents the indexes of segments in segment sets.

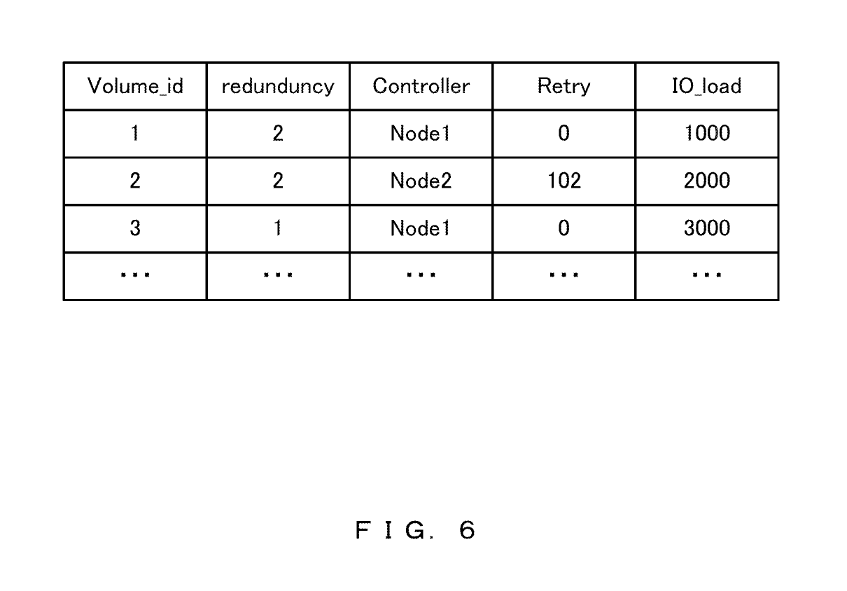

FIG. 6 illustrates an example of a second table managed by the volume management manager 16. “Volume_id” in the second table in the example illustrated in FIG. 6 represents the identification numbers of volumes. “redundancy” represents the degrees of redundancy where the value of “1” represents that the volumes are not mirrored while the value of “2” represents that the volumes are mirrored. “Controller” represents a node responsible for the control of the input/output of the volume. “Retry” represents the number of internal retries. “I/O_load” represents the loads of input/output.

The number of internal retries is the number of times that internal retries to access volumes occurred after access failed due to an error etc. when the input/output control unit 10 tried to access a volume. The number of internal retries increases when for example there is an abnormality in a physical medium such as a disk etc. storing access target data or in an access route.

By for example referring to “Segment_id” on the first table illustrated in FIG. 5, it is possible to recognize from what volume the corresponding segment has been divided. In other words, by referring to the first table managed by the volume management manager 16, it is possible to recognize information related to the distributed arrangement of the segments obtained by the division of a volume. Hereinafter, information related to a distributed arrangement will be referred to as distributed arrangement information. Distributed arrangement information is stored in a memory (not illustrated) in a controller 5D.

### (Example of Metabolism Manager)

As illustrated in FIG. 3, the controller 5D in the new node 4D includes an input/output control unit 10D, cluster control 11D, volume management 12D, and a metabolism manager 13. The input/output control unit 10D controls the input/output of data with respect to the new node 4D. The cluster control 11D conducts control related to the clustering between the plurality of nodes. The volume management 12D manages volumes.

The metabolism manager 13 controls the metabolism. The metabolism will be explained. The metabolism means the replacement of the node 4 whose support period has become close to the expiration with a new node 4 in the system 1 operated by using the plurality of nodes 4. The metabolism manager 13 is an example of a storage control device.

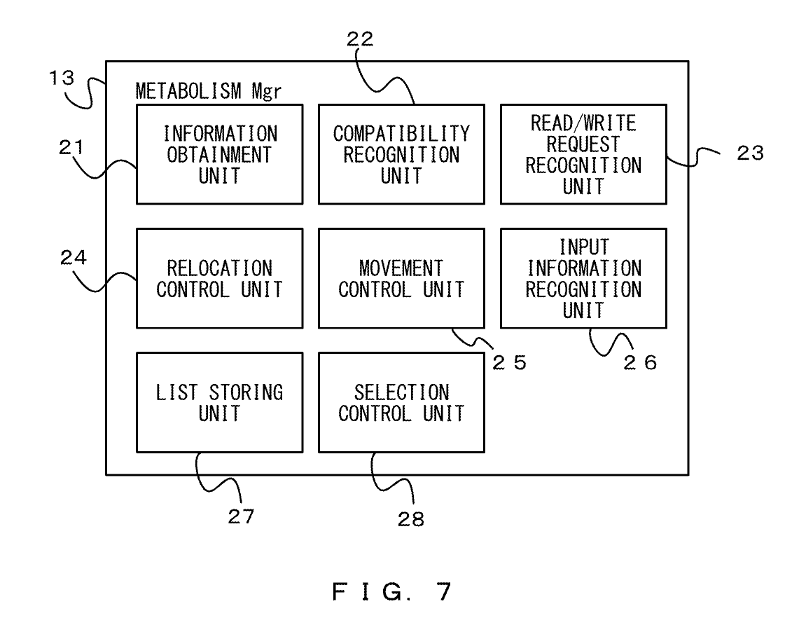

In the example illustrated in FIG. 3, the metabolism manager 13, which controls the metabolism, is included in the controller 5D of the new node 4D. FIG. 7 illustrates an example of functional blocks of the metabolism manager 13. Note that the metabolism manager appears as “metabolism Mgr” in the drawings.

The metabolism manager 13 in the example illustrated in FIG. 7 includes an information obtainment unit 21, a compatibility recognition unit 22, a read/write request recognition unit 23, a relocation control unit 24, a movement control unit 25, an input information recognition unit 26, a list storing unit 27, and a selection control unit 28.

The information obtainment unit 21 obtains distributed arrangement information from the volume management manager 16 of the existing node 4B. For example, information obtainment unit 21 uses the communication function of the new node 4D so as to obtain the distributed arrangement information from the existing node 4B via the switch 3 or the interconnector 7.

The compatibility recognition unit 22 recognizes the compatibility of the interconnector 7. Communication is possible between the nodes 4 that are connected to a compatible interconnector 7. The read/write request recognition unit 23 recognizes that a read request or a write request has been received from the server 2 for the input/output control unit 10D.

The relocation control unit 24 relocates respective segments that have received wide striping. The volume of the replacement node 4A (Vol_1, which will be referred to as volume V1 hereinafter) has been arranged distributedly in the replacement node 4A and at least one existing node. The relocation control unit 24 conducts control of relocating the segments of volume V1 (segments obtained by dividing volume V1) to the storage area 6D of the replacement node 4A.

Also, the relocation control unit 24 conducts control of distributedly arranging, in at least one different node 4, the segments that were relocated to the replacement node 4A. In other words, the relocation control unit 24 conducts wide striping.

The movement control unit 25 moves the input/output control unit 10A of the replacement node 4A to the input/output control unit 10D of the new node 4D. For example, the movement control unit 25 may copy the input/output control unit 10A to the input/output control unit 10D. For this process, it is also possible for example to move the address (for example, a virtual IP (Internet Protocol) address) that has been assigned to the replacement node 4A to the new node 4D. Thereby, the node responsible for volume V1 is changed from the replacement node 4A to the new node 4D.

After moving the input/output control unit 10A, the movement control unit 25 moves all the segments of volume V1 stored in the storage area 6A of the replacement node 4A to the new node 4D. In other words, the movement control unit 25 moves volume V1 from the replacement node 4A to the new node 4D.

The input information recognition unit 26 recognizes input information. When for example a user has input information by using an input unit (not illustrated) provided to a computer (not illustrated) that manages the new node 4D and the system 1, the input information recognition unit 26 recognizes the information input by the user.

The list storing unit 27 stores first and second lists. The first list is related to a volume to be relocated to the replacement node 4A. The second list is related to a volume to be relocated from the replacement node 4A to the existing nodes 4B and 4C. Detailed explanations will be given for this point later. The selection control unit 28 conducts control of selecting a volume to be relocated.

### (Example of Volume Relocation)

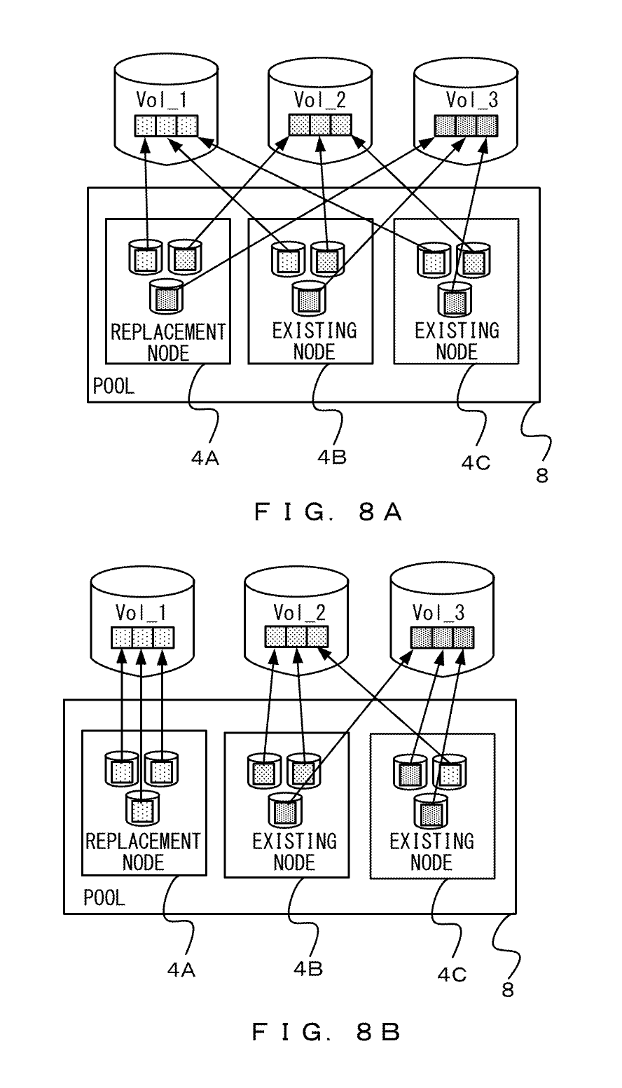

FIG. 8A and FIG. 8B illustrate examples of volume relocation. As illustrated in FIG. 8A, there is volume V1 that corresponds to replacement node 4A. There is also a volume (Vol_2, referred to as volume V2 hereinafter) that corresponds to existing node 4B. Also, there is a volume (Vol_3, referred to as volume V3 hereinafter) that corresponds to existing node 4C.

Each of volumes V1 through V3 has been divided into a plurality of segments and arranged in the respective nodes 4 in an evenly distributed manner. The information obtainment unit 21 obtains distributed arrangement information from the volume management manager 16 of the existing node 4B.

This makes it possible for the relocation control unit 24 to recognize information related to segments of volumes that have been arranged distributedly in the replacement node 4A and the existing nodes 4B and 4C. The relocation control unit 24 conducts control of relocating the segments of volume V1 to the replacement node 4A on the basis of the distributed arrangement information.

The volume to be relocated to the node 4 that is to be replaced is an example of first data, and segments of the corresponding volume are an example of first divisional data. In the embodiments, volume V1 is an example of first data. Also, segments obtained by dividing volume V1 are an example of first divisional data.

Also, on the basis of the distributed arrangement information, the relocation control unit 24 conducts control of relocating, to the existing node 4B or 4C, the segments of volumes V2 and V3, not including volume V1, which are arranged in the replacement node 4A.

A volume that is relocated to at least one existing node from the node 4 that is to be replaced is an example of second data, and segments of the corresponding volume are an example of second divisional data. In the embodiments, volumes V2 and V3 are an example of second data, and the segments of these volumes are an example of second divisional data.

FIG. 8B illustrates the states of the segments to be relocated to the respective nodes 4 after the relocation control unit 24 has relocated the segments. As illustrated in FIG. 8B, all the segments of volume V1 have been relocated to the replacement node 4A.

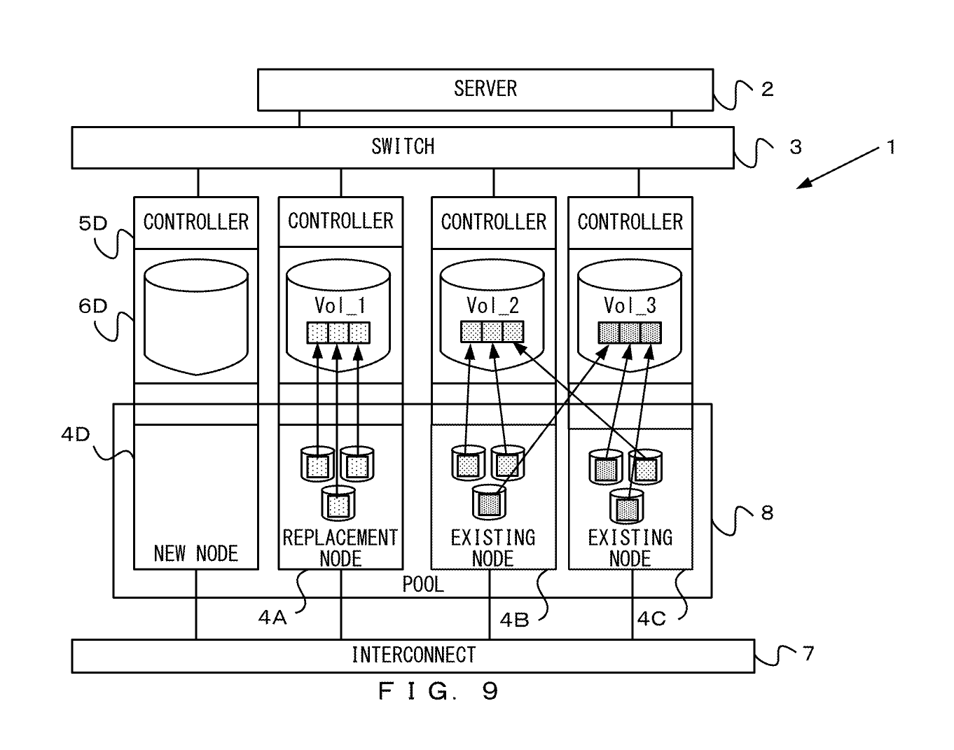

FIG. 9 illustrates an example of the entire system 1 after the relocation of segments as illustrated in FIG. 8B was conducted. As illustrated in FIG. 8B and FIG. 9, the replacement node 4A only stores the segments of volume V1.

In this situation, the relocation control unit 24 may relocate segments of at least one arbitrary volume to the replacement node 4A. When for example many segments of volume V2 have been arranged in replacement node 4A, the relocation control unit 24 relocates the segments of volume V2 from the existing nodes 4B and 4C to the replacement node 4A.

This makes it possible to reduce the amount of data moved to the replacement node 4A. The relocation control unit 24 selects a volume whose data amount to be moved is lower than a prescribed ratio and conducts the relocation of the data to the replacement node 4A. The prescribed ratio can be set arbitrarily. The relocation control unit 24 may select a volume whose data amount to be moved is the smallest from among a plurality of volumes.

Also, the relocation control unit 24 selects a volume having a data size equal to or smaller than each of the capacity of the storage area 6A of the replacement node 4A and the capacity of the storage area 6D of the new node 4D. When for example the data size of volume V1 has exceeded the capacity of the storage area 6A of the replacement node 4A, the relocation control unit 24 conducts control so that corresponding volume V2 or V3 and not volume V1 will be relocated to the replacement node 4A.

The relocation control unit 24 may also select a volume to be relocated to the replacement node 4A in accordance with the input/output load of the volume. When comparison between the new node 4D and the existing nodes 4B and 4C indicates that the new node 4D has a higher performance than that of the existing node 4B and 4C, the relocation control unit 24 selects the volume with the highest input/output load from among the plurality of volumes.

Then, the relocation control unit 24 relocates a volume with a high input/output load to the replacement node 4A. The relocation control unit 24 may also select a volume with an input/output load higher than a prescribed value from among a plurality of volumes so as to relocate the volume to the replacement node 4A. The prescribed value may be set arbitrarily. The relocation control unit 24 may also select the volume with the highest input/output load so as to relocate the selected volume to the replacement node 4A.

When the new node 4D has a higher performance than that of the existing node 4B or 4C, a volume with a high input/output load is moved to the new node 4D. Because the new node 4D can respond to high loads, the system 1 can operate stably.

When the new node 4D has performance lower than that of the existing node 4B or 4C, the relocation control unit 24 selects a volume with a low input/output load from among a plurality of volumes. Then, the relocation control unit 24 may relocate the selected volume to the replacement node 4A.

For example, there are two nodes; the existing node 4B and the existing node 4C. When the input/output performance of the two nodes is higher than that of the new node 4D or in other situations, the relocation control unit 24 relocates a volume with a high input/output load to the existing nodes 4B and 4C. Also, the relocation control unit 24 relocates a volume with a low input/output load to the replacement node 4A.

Accordingly, when the new node 4D has a performance lower than that of the existing node 4B or 4C, the relocation control unit 24 selects a volume with a low input/output load and relocates the volume to the replacement node 4A. For this process, the relocation control unit 24 may select a volume with an input/output load lower than a prescribed value from among a plurality of volumes. The prescribed value may be set arbitrarily. Also, the relocation control unit 24 may select the volume with the lowest input/output load from among a plurality of volumes.

When the new node 4D has a performance lower than that of the existing node 4B or 4C, a volume with a low input/output load is moved to the new node 4D, making it possible for the system 1 to operate stably.

As described above, the relocation control unit 24 may select a volume to be relocated to the replacement node 4A in accordance with the performance of the new node 4D and the existing nodes 4B and 4C and with the input/output load of volumes. In such a case, the metabolism manager 13 stores the values of the performance of the new node 4D and the existing nodes 4B and 4C.

The relocation control unit 24 may also relocate a volume among a plurality of volumes in accordance with the number of internal retries. For example, the relocation control unit 24 may also relocate a volume whose number of internal retries is larger than a prescribed value to the replacement node 4A. The prescribed value may be set arbitrarily. A volume to be relocated to the replacement node 4A is moved to the new node 4D.

In the above manner, by relocating a volume with a large number of internal retries to the replacement node 4A, the corresponding volume can operate stably in the new node 4D. The relocation control unit 24 may also select the volume with the largest number of internal retries from among a plurality of volumes so as to relocate the selected volume to the replacement node 4A.

The new node 4D often has a higher reliability than that of the existing node 4B or 4C. By the relocation control unit 24 moving a volume with a large number of internal retries to a highly reliable new node 4D, it is possible to operate the system 1 stably.

The relocation control unit 24 may also select a non-mirrored volume from among a plurality of volumes so as to relocate the selected volume to the replacement node 4A. A volume is mirrored and the mirror volume is stored in the pool 8 as a mirror volume in some cases. Accordingly, a non-mirrored volume is a volume before being mirrored.

It is desirable that a non-mirrored volume be operated by a highly reliable node 4. The new node 4D is often more reliable than the existing node 4B and 4C, and in such a case, a non-mirrored volume may be relocated to the replacement node 4A among a plurality of volumes by the relocation control unit 24. Note that a plurality of volumes may be relocated to the replacement node 4A.

Next, explanations will be given for at least one volume that has not been relocated to the replacement node 4A. In some cases, there are a plurality of nodes 4 that are to be replaced. When there is one node 4 to be replaced (referred to as the replacement node 4A), at least one volume that has not been relocated to the replacement node 4A is arranged distributedly in the existing nodes 4B and 4C by the relocation control unit 24. In other words, when there is one node 4 to be replaced, the relocation control unit 24 may conduct wide striping on a volume by using a plurality of existing nodes 4.

When a plurality of nodes 4 are to be replaced, the relocation control unit 24 does not need to conduct wide striping. When a plurality of nodes 4 are to be replaced, the relocation control unit 24 relocates a volume to the respective nodes 4 that are to be replaced. Accordingly, by refraining from conducting wide striping after the relocation of a volume to the first node 4 to be replaced, the relocation of a volume to the second and subsequent nodes 4 to be replaced can be conducted highly efficiently.

Also, when there is one node 4 to be replaced (replacement node 4A), the relocation control unit 24 may refrain from conducting a distributed arrangement for a volume that can be responded to by the performance of one node 4. When the subsequent nodes 4 are replaced, the relocation control unit 24 relocates a volume to the nodes 4 to be replaced. When the distributed arrangement of a volume has not been conducted at that moment, the relocation control unit 24 can relocate a volume efficiently.

### (Example of Movement of Volume)

Next, an example of the movement of a volume will be explained. As described above, the relocation control unit 24 relocates segments of a volume to the node 4 to be replaced from at least one existing node 4. It is assumed hereinafter that “the node 4 to be replaced” is the replacement node 4A and “at least one existing node 4” is the existing nodes 4B and 4C.

By the relocation control unit 24 relocating all segments of a volume, the volume is relocated to the storage area 6A of the replacement node 4A. This volume is treated as volume V1 described above.

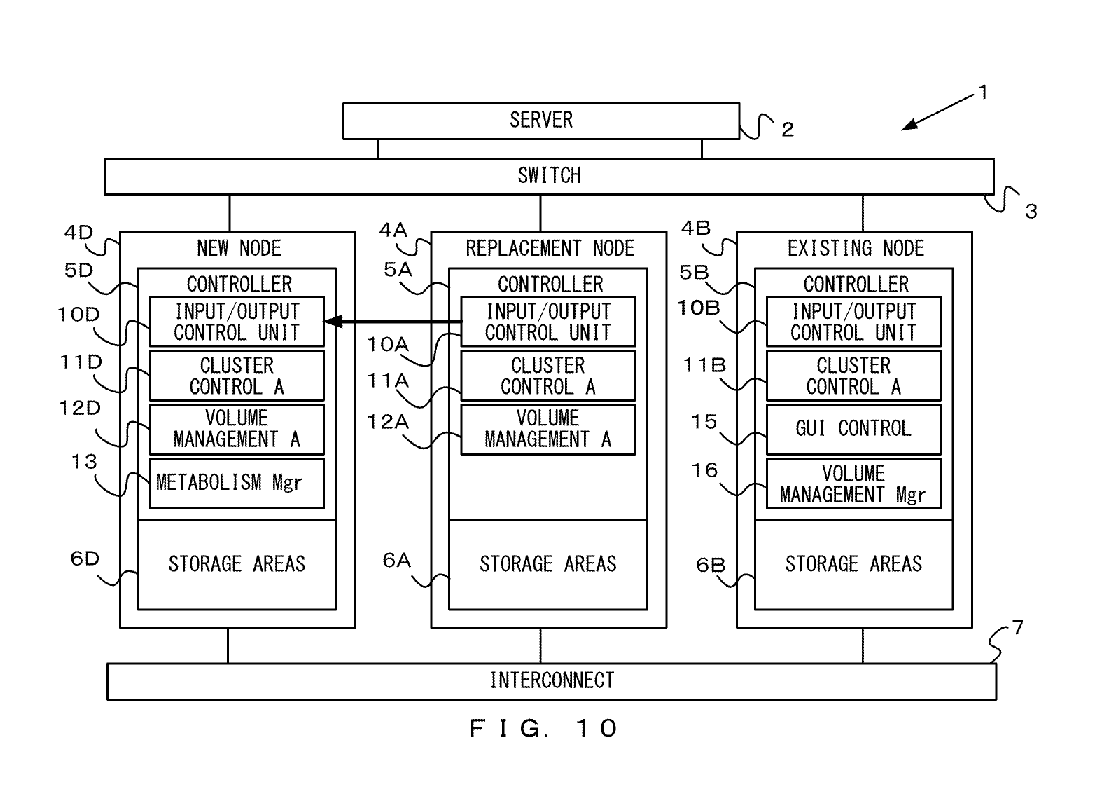

As illustrated in FIG. 10, the movement control unit 25 moves the input/output control unit 10A of the replacement node 4A to the new node 4D. For example, the movement control unit 25 copies the functions of the input/output control unit 10A to the input/output control unit 10D. Thereby, the responsibility for volume V1 is changed from replacement node 4A to new node 4D.

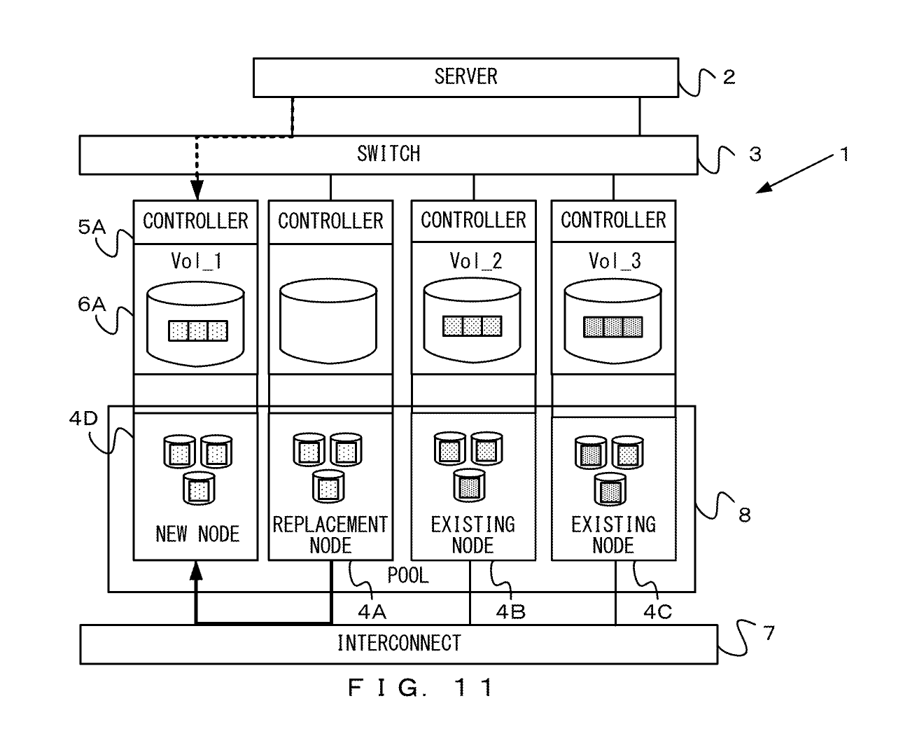

Next, as illustrated in FIG. 11, the movement control unit 25 moves, via the interconnector 7, volume V1 relocated to the storage area 6A of the replacement node 4A to the storage area 6D of the new node 4D. The movement control unit 25 may move volume V1 to the new node 4D for each segment.

While the movement control unit 25 is moving volume V1 from the replacement node 4A to the new node 4D, the server 2 makes read access or write access to volume V1 in some cases. Note that volume V1 to be moved is represented by a solid line while the read access or the write access is represented by a dotted line.

When the server 2 makes write access to volume V1 during the movement of volume V1, the read/write request recognition unit 23 recognizes the write access to volume V1. The movement control unit 25 stores data that is the target of the write access in the storage area 6D of the new node 4D.

When the server 2 makes read access to volume V1 during the movement of volume V1, the read/write request recognition unit 23 recognizes the read access to volume V1.

During the movement of volume V1, segments that have already been moved are stored in the storage area 6D of the new node 4D; however, segments before being moved are stored in the storage area 6A of the replacement node 4A.

Accordingly, in the case of read access to a segment that has already been moved to the new node 4D, the movement control unit 25 conducts control so that the target of the read access is the storage area 6D of the new node 4D. In the case of read access to a segment that has not been moved to the new node 4D, the movement control unit 25 conducts control so that the target of the read access is the storage area 6A of the replacement node 4A.

Thereby, it is possible for the system 1 to operate stably even when the server 2 has made read access or write access to volume V1 while volume V1 is being moved.

As described above, the movement control unit 25 moves the input/output control unit 10A of the replacement node 4A to the new node 4D, and thereby the new node 4D becomes responsible for volume V1, which is to be moved. Thereafter, the movement control unit 25 moves volume V1 from the replacement node 4A to the new node 4D, making it possible to replace a node while maintaining the continuity of the operation of the system 1. It is also possible to replace a node without changing the setting of the server 2.

Also, when the server 2 makes read access or write access to volume V1 during the movement of volume V1, the movement control unit 25 conducts the control described above, making it possible to maintain normal operations of the system 1.

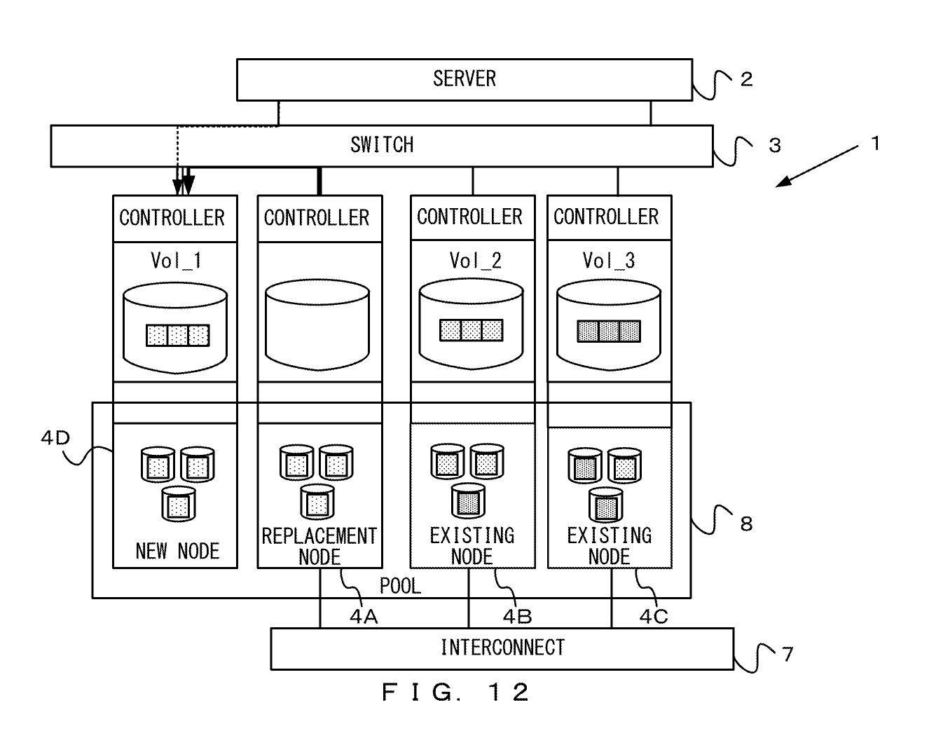

FIG. 12 illustrates a case where there is interconnector 7 compatibility between the replacement node 4A and the existing nodes 4B and 4C while the interconnector 7 does not have compatibility with the new node 4D. In such a case, it is not possible for the movement control unit 25 to move volume V1 from the replacement node 4A to the new node 4D via the interconnector 7. Accordingly, the movement control unit 25 conducts, via the switch 3, control of moving volume V1 from the replacement node 4A to the new node 4D.

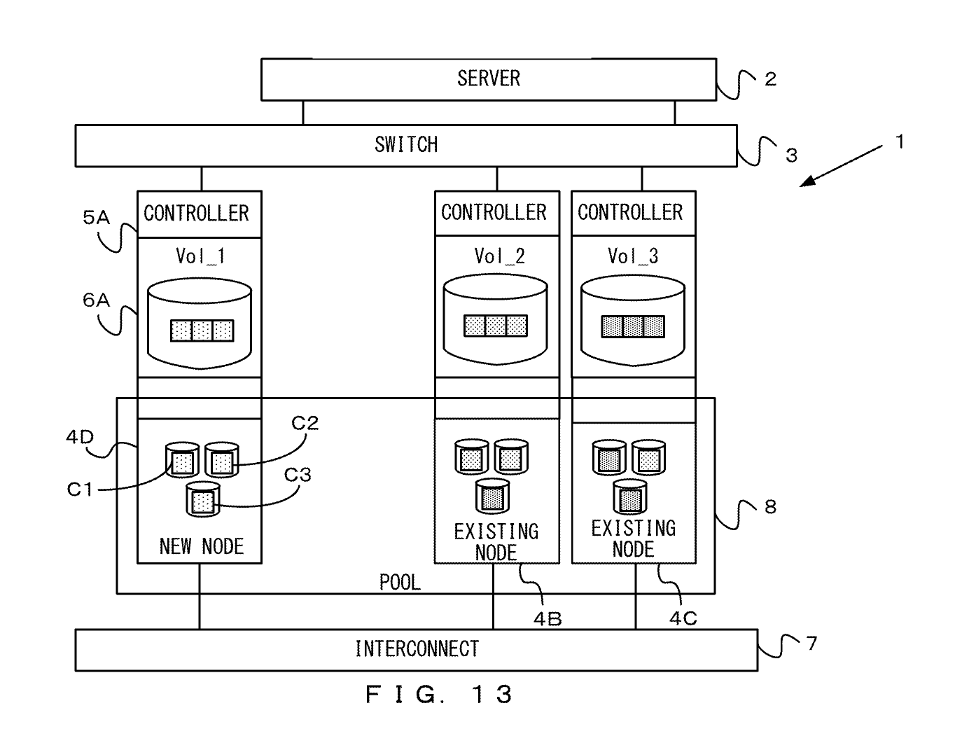

FIG. 13 illustrates a state in which the movement control unit 25 has separated the replacement node 4A from the system 1. The responsibility for volume V1, which was borne by the replacement node 4A, has been moved to the new node 4D. Also, volume V1 has been moved to the storage area 6A of the new node 4D.

As described above, the relocation control unit 24 has relocated, to the replacement node 4A, the segments of volume V1 that were arranged in the replacement node 4A and the existing nodes 4B and 4C. Thereafter, the movement control unit 25 has moved volume V1 from the replacement node 4A to the new node 4D.

Accordingly, the movement control unit 25 only has to move, to the new node 4D, the segments of volume V1 collected at the replacement node 4A as they are, making the data movement efficient.

Also, the movement control unit 25 moved volume V1 after moving the input/output control unit 10A of the replacement node 4A to the new node 4D. This makes it possible to move data while continuing the operation of the system 1.

(Example of Distributed Arrangement after Data Movement)

Next, explanations will be given for an example of distributed arrangement after data movement. As illustrated in FIG. 13, the system 1 is being operated while including the new node 4D and the existing nodes 4B and 4C. The new node 4D stores all the segments of volume V1. In the example of FIG. 13, the new node 4D stores segments C1 through C3 of volume V1.

Scale-out storage conducts wide striping so as to eliminate the concentration of input/output loads, thereby enabling efficient operations of the system 1. Because of this, it is desirable that the new node 4D distributedly arrange segments C1 through C3.

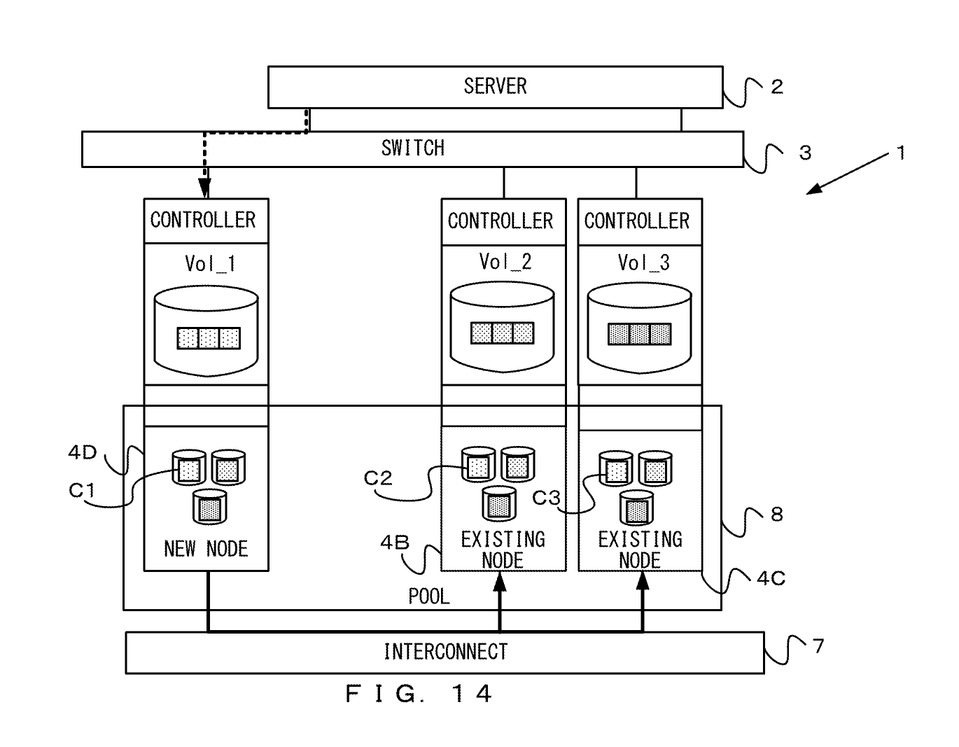

FIG. 14 illustrates a case where the relocation control unit 24 has relocated segment C2 to the existing node 4B via the interconnector 7, and has also relocated segment C3 to the existing node 4C. Note that the relocation control unit 24 has not moved segment C1 from the new node 4D. Accordingly, segments C1 through C3 are wide striped so that they are relocated to the respective nodes 4.

The compatibility recognition unit 22 recognizes whether or not the new node 4 has compatibility with the interconnector 7. When the compatibility recognition unit 22 has recognized that the new node 4 has compatibility with the interconnector 7, the relocation control unit 24 conducts wide striping on segments C1 through C3.

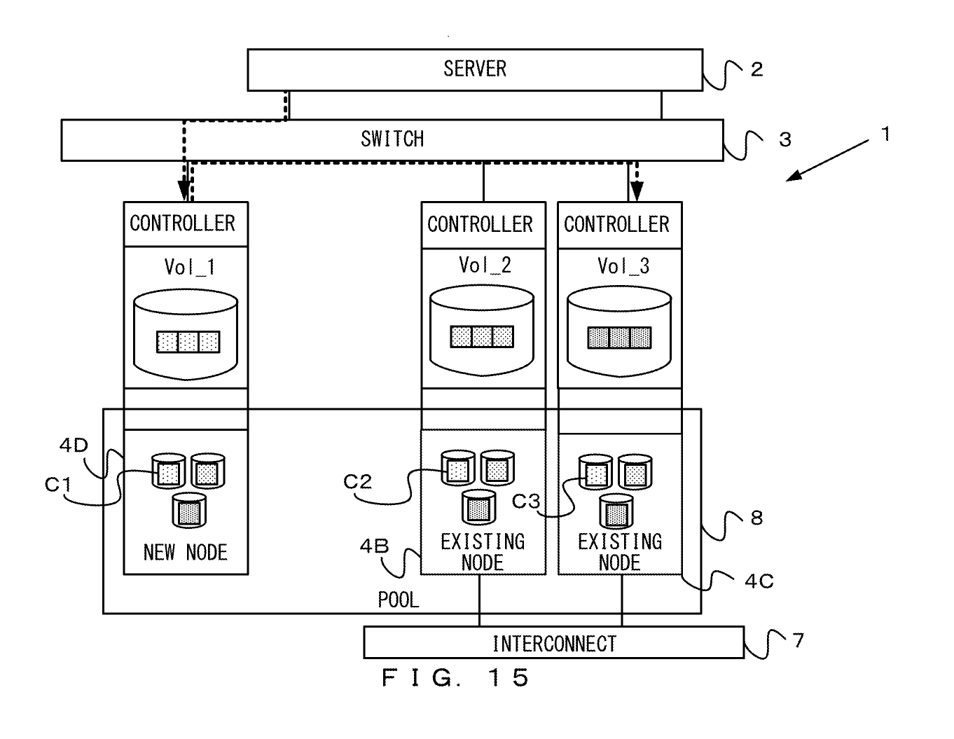

When it has been recognized that the new node 4 does not have compatibility with the interconnector 7, the relocation control unit 24 does not need to conduct wide striping. As illustrated in FIG. 15, the server 2 accesses the respective nodes 4 via the switch 3.

When the server 2 accesses segment C3 of volume V1, the access is made to the new node 4 that is responsible for volume V1. When, as illustrated in FIG. 15, the wide striping has relocated segment C3 to the storage area 6C of the existing node 4C, access is again made via the switch 3. In other words, access is again made to the existing node 4C from the new node 4D via the switch 3.

In such a case, loads on the switch 3 increase. When the new node 4 has compatibility with the interconnector 7, it is also possible to again make access from the new node 4D to the existing node 4C. However, when the new node 4 does not have compatibility with the interconnector 7, the switch 3 is used, leading to increased loads on the switch 3.

Thus, it is also possible for the relocation control unit 24 to refrain from conducting wide striping on segments C1 through C3 of the new node 4 when the compatibility recognition unit 22 has recognized that the new node 4 does not have compatibility with the interconnector 7. However, it is also possible for the relocation control unit 24 to conduct wide striping when the switch 3 is highly resistant to high loads or in other cases.

### (Example of Replacing a Plurality of Nodes)

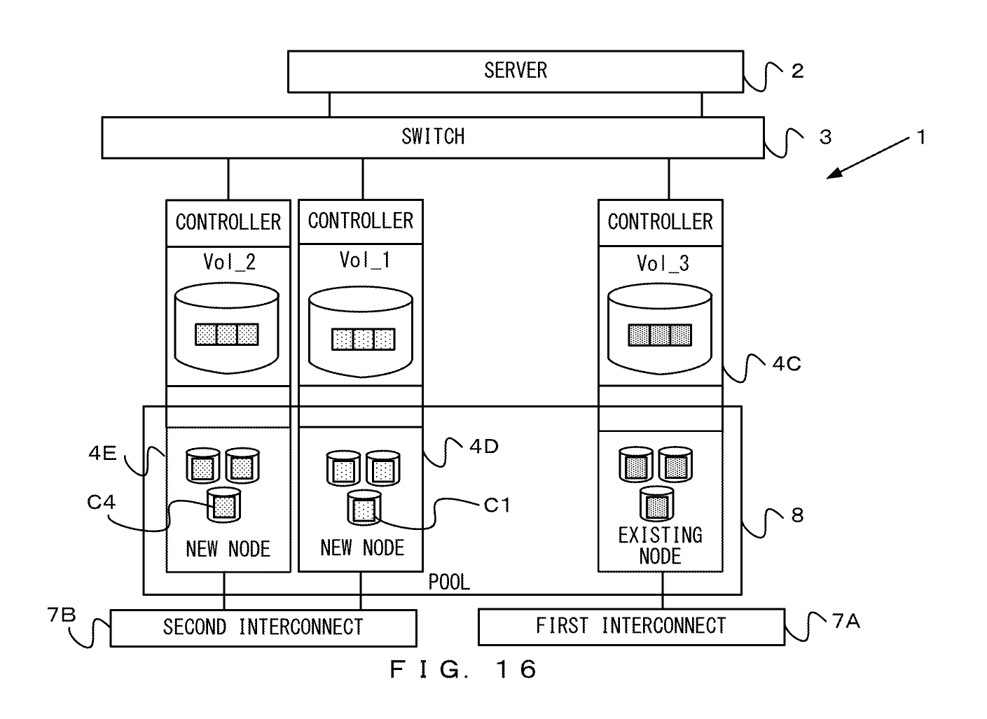

FIG. 16 illustrates an example in which the existing node 4B became a replacement node, and that replacement node has been replaced with a new node 4E. The replacement in which the existing node 4B has become a replacement node and that replacement node is replaced with the new node 4D is similar to the replacement of the replacement node 4A with the new node 4D.

FIG. 16 illustrates an example in which two nodes, the new nodes 4D and 4E, are replaced. First interconnect 7A has been connected to the existing node 4C. Second interconnect 7B has been connected to the new nodes 4D and 4E.

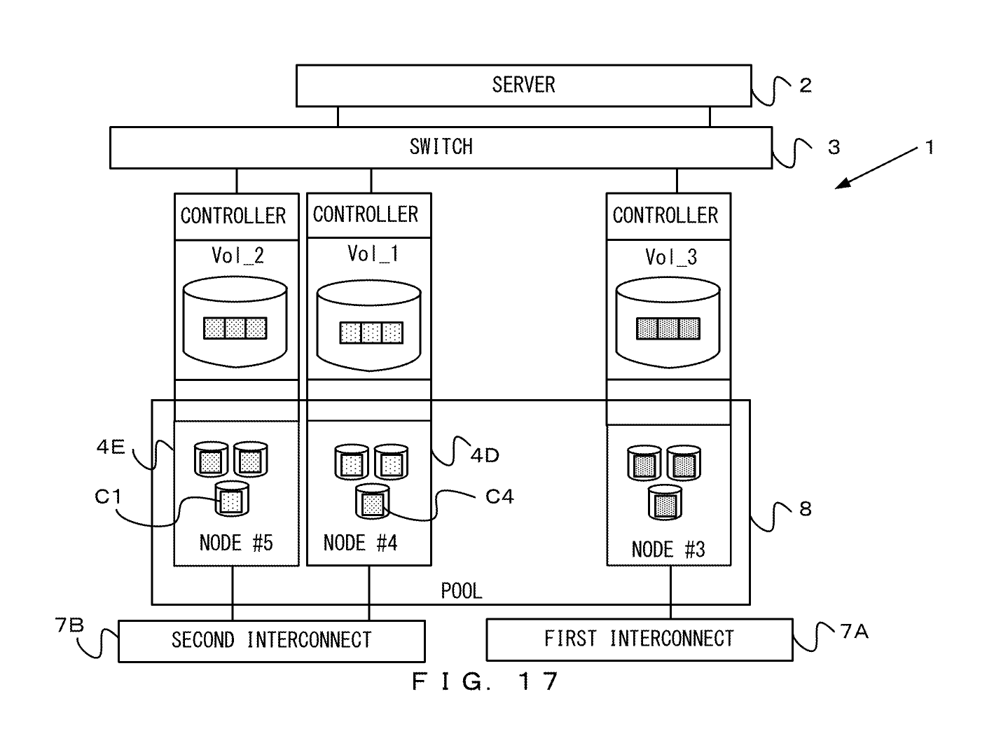

The relocation control unit 24 of the metabolism manager 13 of either the new node 4D or 4E conducts wide striping via the second interconnect 7B. FIG. 17 illustrates an example thereof.

In the example illustrated in FIG. 17, segment C1 of new node 4D has been moved to the new node 4E. Also, segment C4 of the new node 4E has been moved to the new node 4D. The relocation control unit 24 may conduct wide striping as illustrated in the example of FIG. 17.

### (First Selection Process)

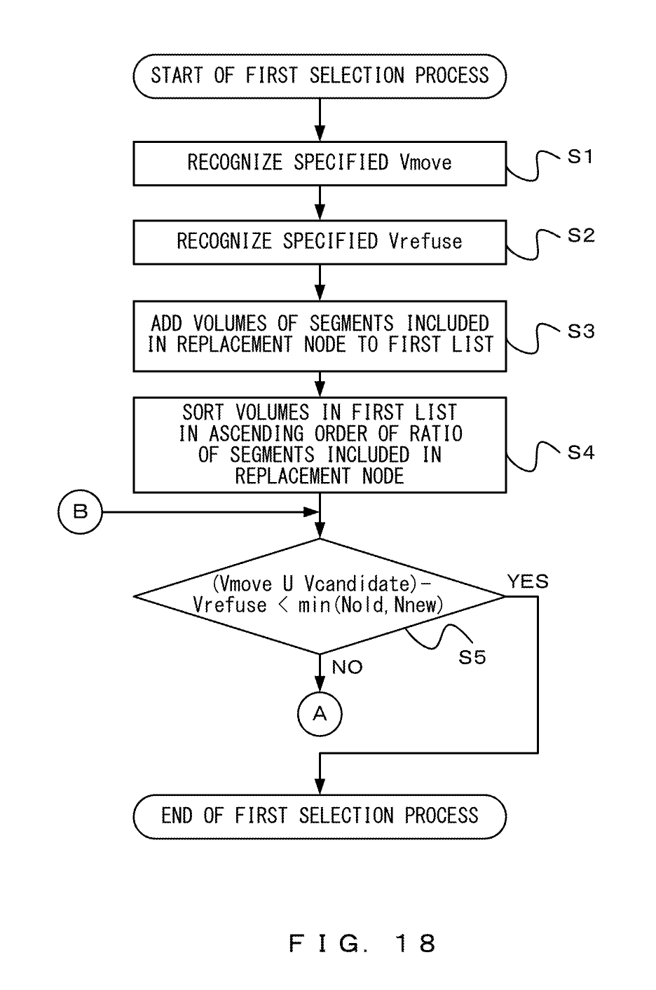

Next, explanations will be given for a first selection process by referring to FIG. 18. The first selection process is a process of selecting at least one volume to be relocated to the replacement node 4A. A volume selected in the first selection process is relocated to the replacement node 4A, and thereafter is moved to the new node 4D.

Users can use the input unit described above so as to specify a volume to be moved. Also, users can use the input unit to specify a volume that is not to be moved. It is assumed that a volume specified by a user as a volume to be moved is “Vmove”. The input information recognition unit 26 recognizes this “Vmove” (S1). It is also assumed that a volume specified by a user as a volume that is not to be moved is “Vrefuse”. The input information recognition unit 26 recognizes this “Vrefuse” (S2).

The selection control unit 28 adds, to the first list, the volume of the segments stored in the storage area 6A of the replacement node 4A. The first list is a list related to a volume that is a candidate for a volume to be relocated to the replacement node 4A.

As described above, according to scale-out storage, when segments of volumes have received wide striping, one node 4 includes segments of different volumes. Therefore, the replacement node 4A may also include segments of different volumes in some cases. When for example the replacement node 4A includes segments of volumes V1 through V3, the selection control unit 28 adds volumes V1 through V3 to the first list (S3).

The selection control unit 28 sorts volumes V1 through V3 included in the first list in ascending order of ratio at which segments are included in the replacement node 4A (S4). It is assumed that a volume included in the first list is “Vcandicate”.

The selection control unit 28 conducts calculations of a sum set of “Vmove” and “Vcandidate”. In FIG. 18, it is referred to as “Vmove U Vcandidate”. By this calculation of sum set, a plurality of volumes are selected.

Then, a volume of “Vrefuse” is excluded from a plurality of volumes obtained as a result of the calculation of sum set. In FIG. 18, the result is referred to as “(Vmove U Vcandidate)−Vrefuse”. Thereby, at least one volume is selected.

Also, it is assumed that the capacity of the storage area 6A of the replacement node 4A is “Nold” and the capacity of the storage area 6D of the new node 4D is “Nnew”. “min(Nold,Nnew)” represents the capacity of the volume that is smaller between “Nold” and “Nnew”.

The selection control unit 28 determines whether or not the size of at least one volume selected by “(Vmove U Vcandidate)−Vrefuse” is smaller than “min(Nold,Nnew)” (S5). In FIG. 18, it is referred to as “(VmoveUVcandidate)−Vrefuse<min(Nold,Nnew)”.

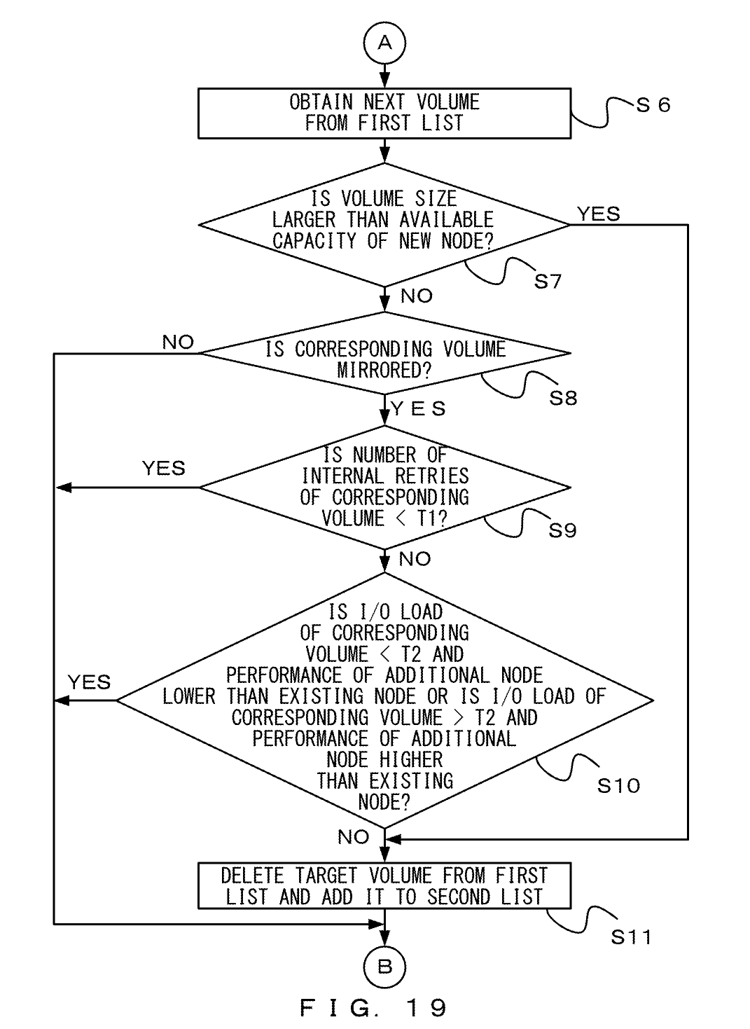

When the determination result in S5 is No, the process proceeds to “A”. FIG. 19 illustrates the processes of “A”. The selection control unit 28 sequentially obtains volumes that are sorted in ascending order of ratio of segments (S6).

The selection control unit 28 determines whether or not the size of the selected volume is larger than the available capacity of the new node 4D (S7). When the determination result in S7 is No, i.e., when the size of the selected volume is equal to or smaller than the available capacity of the new node 4D, the volume can be moved to the new node 4D.

When the determination result in S7 is No, the selection control unit 28 determines whether or not the volume obtained in S6 has been mirrored (S8). In other words, the selection control unit 28 determines whether or not the volume is a non-mirrored volume.

When the determination result in S8 is Yes, i.e., when the obtained volume is a mirrored volume, the selection control unit 28 determines whether or not the number of internal retries of the obtained volume is smaller than threshold T1 (S9). Threshold T1 can be set to an arbitrary value.

When the determination result in S9 is No, i.e., when the number of internal retries of the obtained volume is large (larger than threshold T1), the selection control unit 28 determines whether or not the following two conditions are met. The first condition is that “the input/output load on the obtained volume is smaller than threshold T2 and the performance of the new node 4D is lower than that of the existing node 4B and 4C”.

Threshold T2 can be set arbitrarily. For example, a specific value may be set in advance as threshold T2. Also, the average of input/output loads of volumes included in the first list may be used as threshold T2.

The second condition is that “the input/output load on the obtained volume is larger than threshold T2 and the performance of the new node 4D is higher than that of the existing node 4B or 4C”. The selection control unit 28 determines whether or not either the first or second condition is met (S10).

When neither of the conditions is met, the determination result in S10 is No. In such a case, the selection control unit 28 deletes the target volume from the first list and adds the corresponding volume to the second list (S11). The second list is a list related to a volume to be relocated from the replacement node 4A to the existing nodes 4B and 4C. Accordingly, the target volume is excluded from candidates for movement targets.

When the determination result in S7 is Yes, i.e., when the size of the selected volume is larger than the available capacity of the new node 4D, the volume is not moved to the new node 4D. Accordingly, the selection control unit 28 deletes the target volume from the first list without conducting the processes in S8 through S10, and adds that target volume to the second list.

When the determination result in S8 is No, when the determination result in S9 is Yes, when the determination result in S10 is Yes, and after the process in S11 has been conducted, the process proceeds to “B”. In other words, the process returns to S5 in FIG. 18.

When the determination result in S8 is No, i.e., when the volume is a non-mirrored volume, the corresponding volume is not deleted from the first list. Also, when the determination result in S9 is Yes, i.e., when the number of internal retries of the corresponding volume is smaller than threshold T1, the corresponding volume is not deleted from the first list.

When the determination result in S10 is Yes, i.e., when either the first or the second condition is met, the corresponding volume is not deleted from the first list. When the process in S11 has been conducted, the corresponding volume is deleted from the first list.

When the process in S11 has been conducted, the process proceeds from “B” to S5. Because one volume has been deleted from the first list by then, the amount of “Vcandidate” has been reduced from when the process in S5 was conducted previously.

By repeating the above processes, the selection control unit 28 selects a volume to be relocated to the replacement node 4A. The selected volume becomes a volume to be moved from the replacement node 4A to the new node 4D.

### (Second Selection Process)

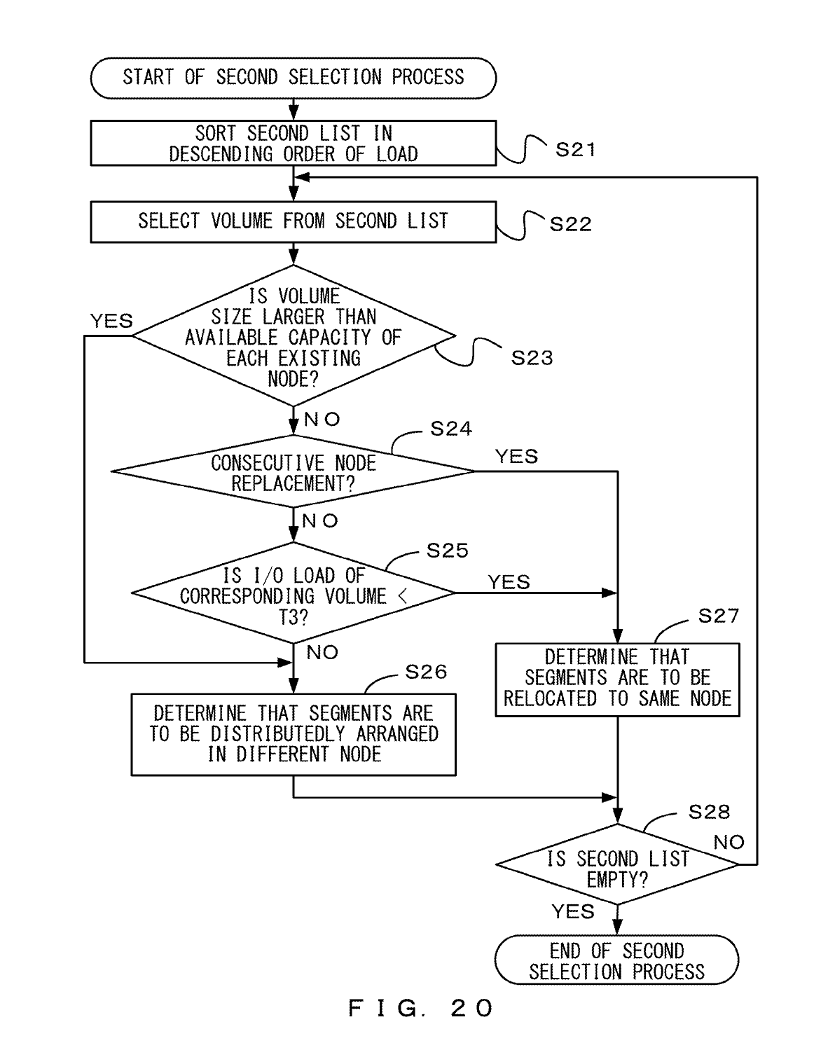

Next, by referring to FIG. 20, the second selection process will be explained. The second selection process is a process in which a volume to be relocated from the replacement node 4A to the existing nodes 4B and 4C is selected. At least one volume is selected in the second selection process.

When the first selection process has been terminated, at least one volume is selected as a movement target. Therefore, each time the process in S11 of the first selection process is conducted, a volume is added to the second list.

The selection control unit 28 sorts volumes in the second list in descending order of load (S21). The selection control unit 28 selects one volume from the second list (S22). The selection control unit 28 determines whether or not the size of the selected volume is larger than the available capacity of each existing node (S23).

When the determination result in S23 is No, the selection control unit 28 determines whether or not node replacement is to be conducted consecutively (S24). When the determination result in S24 is No, the selection control unit 28 determines whether or not the input/output load of the corresponding volume is smaller than threshold T3 (S25). Threshold T3 may be set to an arbitrary value.

When the determination result in S25 is No, i.e., when the input/output load of the volume selected in S22 is larger, the selection control unit 28 determines that the segments of the volume are to be distributedly arranged in different nodes 4 (S26). In other words, the selection control unit 28 determines that the segments of the volume are wide striped so that they are arranged in the existing nodes 4B and 4C.

When the determination result in S23 is Yes, i.e., when the volume size is larger than the available capacity of each existing node, the process proceeds to S26, and the selection control unit 28 conducts distributed arrangement on segments obtained by dividing the volume.

When the determination result in S24 is Yes, i.e., in the case of consecutive node replacement, the selection control unit 28 determines that segments are to be relocated to the same node (S27). When the determination result in S25 is Yes, i.e., when the input/output load of the corresponding volume is lower, the selection control unit 28 determines that segments are to be relocated to the same node.

The process in S26 or S27 is a determination related to the arrangement of volumes, but actually the volumes have not yet been arranged in the process. Next, the selection control unit 28 determines whether or not the second list has become empty (S28).

When the determination result in S28 is No, a volume remains in the second list. Accordingly, the process proceeds to S22. When the determination result in S28 is Yes, no volumes remain in the second list, and accordingly the process terminates.

### (Relocation Control Process)

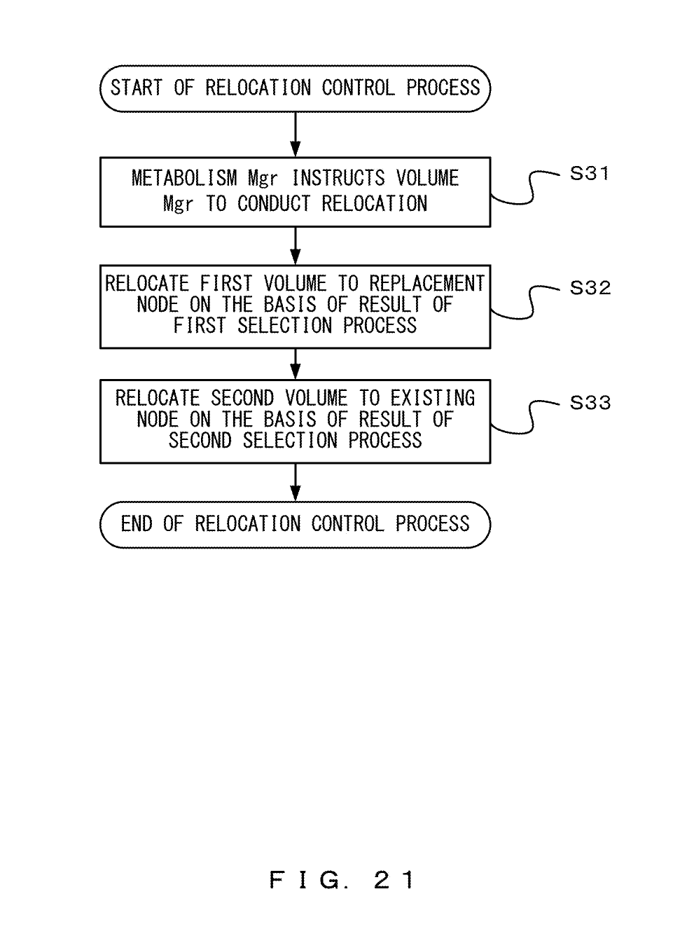

Next, by referring to FIG. 21, the relocation control process will be explained. The relocation control process is a process of actually relocating segments of volumes. First, the metabolism manager 13 gives to the volume management manager 16 of the existing node 4B an instruction to conduct relocation (S31).

In accordance with this instruction of relocation, the volume management manager 16 relocates segments of volumes. Note that the volume management manager 16 may be in the existing node 4C. In such a case, the relocation control unit 24 controls the volume management manager 16 of the existing node 4C so that it conducts relocation (S32).

By the first selection process, a volume to be relocated to the replacement node 4A has been selected. In the embodiment, the selected volume is volume V1. Accordingly, the volume management manager 16 relocates segments of volume V1 to the storage area 6A of the replacement node 4A.

Next, in accordance with the result of the second selection process, the relocation control unit 24 controls the volume management manager 16 so that it relocates segments of the volume from the replacement node 4A to the existing nodes 4B and 4C (S33).

It has been determined, by the second selection process, for at least one volume whether the segments are to be arranged distributedly in the existing nodes 4B and 4C or to be arranged in one existing node 4B or 4C. On the basis of this determination, the relocation control unit 24 controls the relocation.

### (Movement Control Process)

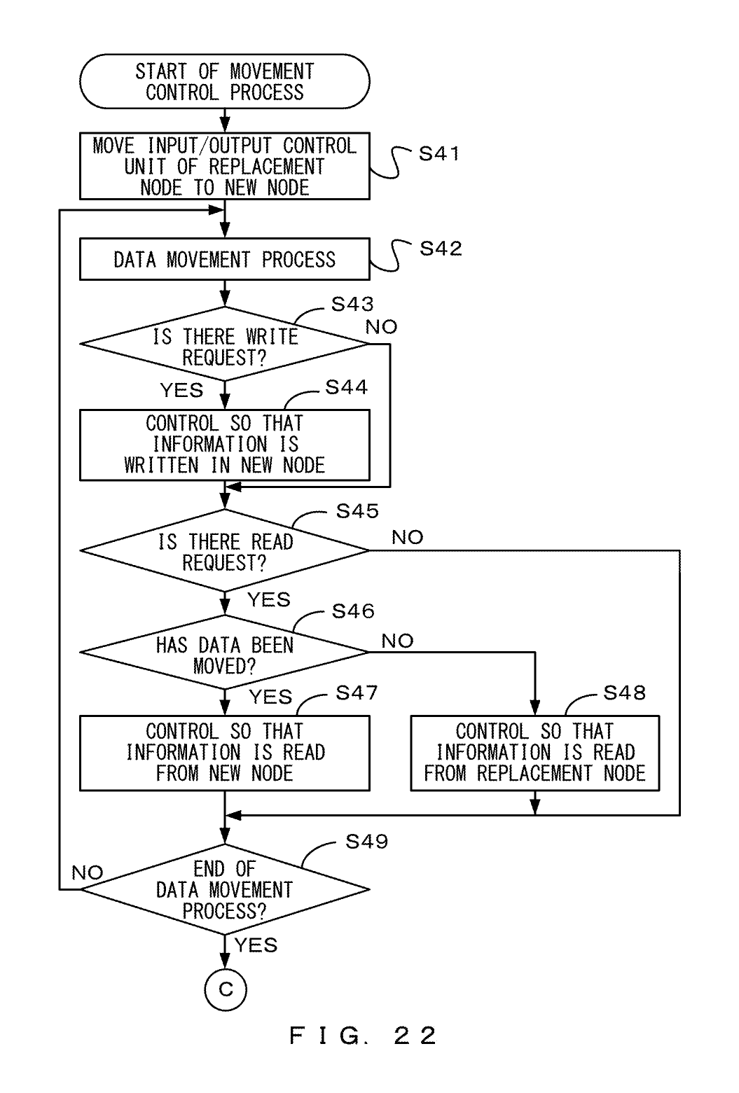

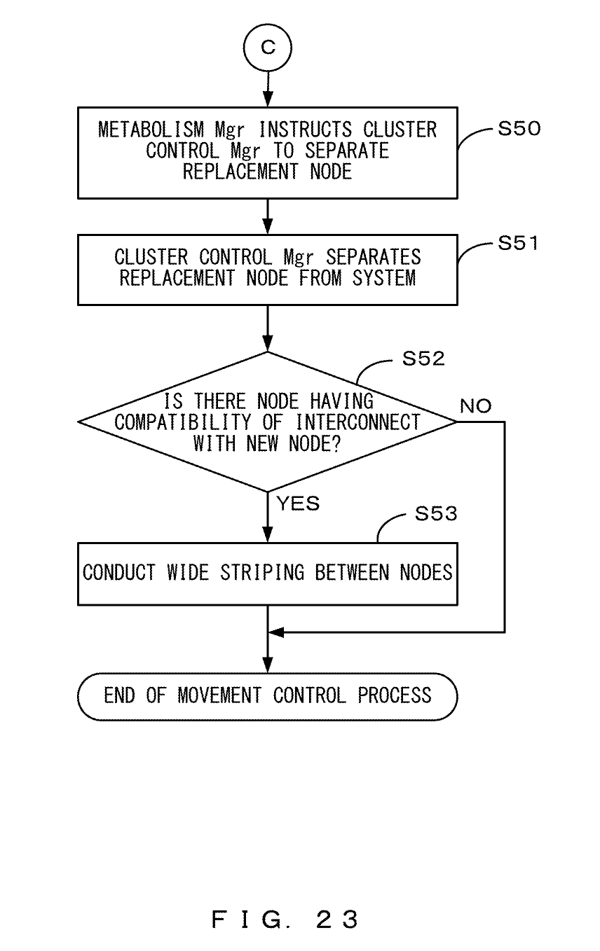

Next, by referring to FIG. 22 and FIG. 23, the movement control process will be explained. By conducting the relocation control process, segments of volume V1 are relocated to the storage area 6A of the replacement node 4A. First, the movement control unit 25 moves the input/output control unit 10A of the replacement node 4A to the input/output control unit 10D of the new node 4D (S41).

Thereby, the node responsible for volume V1 is changed to the new node 4D. After the execution of S41, the movement control unit 25 executes a process of moving data from the replacement node 4A to the new node 4D (S42). In other words, the movement control unit 25 moves volume V1 from the replacement node 4A to the new node 4D.

While moving volume V1, the movement control unit 25 determines whether or not there has been a write request (write access) made by the server 2 to volume V1 (S43). When there has been write access, the input/output control unit 10D controls the new node 4D so that it makes that write access (S44) to the new node 4D (S44). When the determination result in S43 is No, the process in S44 is not conducted.

While moving volume V1, the movement control unit 25 determines whether or not there has been a read request (read access) made by the server 2 to volume V2 (S45). When the determination result in S45 is Yes, the movement control unit 25 determines whether or not segments that are the targets of the read access have already been moved to the new node 4D (S46).

When the determination result in S46 is Yes, i.e., when the segments that are the targets of the read access have already been moved to the new node 4D, the input/output control unit 10D conducts control so that the corresponding read access is made to the new node 4D (S47). In other words, the input/output control unit 10D conducts control so that data is read from the new node 4D.

When the determination result in S46 is No, i.e., when the segments that are the targets of the read access have not been moved to the new node 4D, the input/output control unit 10D conducts control so that the corresponding read access is made to replacement node 4A (S48). In other words, the input/output control unit 10D conducts control so that data is read from the replacement node 4A.

When the determination result in S45 is No (i.e., when there is no read access) or when the process in S47 or S48 has been conducted, the selection control unit 28 determines whether or not the data movement process has been terminated (S49). In other words, it is determined whether or not all the segments in the volume have been moved from the replacement node 4A to the new node 4D.

When the determination result in S49 is No, the process returns to S42. Then, the movement process of the segments of volume V1 is conducted. When the determination result is Yes in S49, the process proceeds to “C”. Explanations will be given for the processes in and subsequent to “C” by referring to FIG. 23.

When the movement of all the segments of volume V1 from the replacement node 4A to the new node 4D has been terminated, the replacement node 4A can be separated from the system 1. Accordingly, the metabolism manager 13 gives the volume management manager 16 an instruction to separate the replacement node 4 from the system 1 (S50). In accordance with this instruction, the volume management manager 16 separates the replacement node 4 from the system 1 (S51).

The movement control unit 25 determines whether or not there is a node 4 that has interconnector 7 compatibility with the new node 4D (S52). When the determination result in S52 is Yes, the movement control unit 25 conducts wide striping between the new node 4D and a different node 4 (existing nodes 4B and 4C in this example) (S53). When the determination result is No in S52, wide striping is not conducted. Thereby, the movement control process is terminated.

### (Hardware Configuration of Controller of New Node)

Next, explanations will be given for a hardware configuration of the controller 5D of a new node. FIG. 14 illustrates an example of a hardware configuration of a new node according to the embodiment.

In FIG. 14, the controller 5D of the new node 4D includes a CPU 601, a memory 602, a reading device 603, and a communication interface 604. The CPU 601, the memory 602, the reading device 603, and the communication interface 604 are connected via a bus.

The CPU 601 uses the memory 602 to execute a program in which the processes in the above flowcharts are described, and thereby provides some or all of the functions of the respective units except for the list storing unit 27 of the metabolism manager 13 of the controller 5D. The program executed by the CPU 601 may be a storage control program.

The memory 602 is for example a semiconductor memory and is configured to include a RAM (Random Access Memory) area and a ROM (Read Only Memory) area. The memory 602 provides some or all of the functions of the list storing unit 27.

The reading device 603 accesses a detachable storage medium 650 in accordance with an instruction given by the CPU 601. The detachable storage medium 650 is implemented by for example a semiconductor device (USB memory etc.), a medium that information is input into or output from by using magnetic effects (magnetic disk etc.), a medium that information is input into or output from by using optical effects (CD-ROM, DVD, etc.), etc. Note that the reading device 603 does not need to be included in the controller 5D.

Part of the controller 5D of the embodiment may be implemented by hardware. It is also possible to implement the controller 5D of the embodiment by a combination of hardware and software.

Note that the scope of the present embodiments is not limited to the above examples, and can employ various configurations or embodiments without departing from the spirit of the present embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control device comprising:
a processor that executes a process including:
conducting, on the basis of information related to distributed arrangement in a case when first divisional data obtained by dividing first data has been arranged distributedly in a first storage and in at least one different storage different from the first storage, control of relocating the first divisional data to the first storage from the different storage; and
conducting control of moving the first data stored in the first storage from the first storage to a second storage after moving a control unit from the first storage to the second storage, the control unit being configured to conduct input or output control of the first data.

2. The storage control device according to claim 1, wherein
the control of relocation conducts control of relocating second divisional data in the first storage to the different storage, the second divisional data having been obtained by dividing second data other than the first data.

3. The storage control device according to claim 1, wherein
the control of movement makes the control unit conduct control so that a target of write access is the second storage in a case when write access was made to the first data while moving the first data, and makes the control unit conduct control so that a target of read access is the second storage when the target of the read access has been moved to the second storage while making the control unit conduct control so that the target of the read access is the first storage when the target of the read access has not been moved to the second storage in a case when read access was made to the first data.

4. The storage control device according to claim 1, wherein
the control of relocation conducts control so that the first data stored in the second storage is arranged distributedly in the different storage in a case when connection compatibility exists between the second storage and the different storage and so that the distributed arrangement is not conducted in a case when the compatibility does not exist.

5. The storage control device according to claim 1, wherein
the control of relocation selects data as the first data in accordance with an amount of data to be moved, from among a plurality of pieces of data arranged in the first storage or the different storage.

6. The storage control device according to claim 1, wherein
the control of relocation selects data of a size equal to or smaller than a capacity of the first storage or the second storage as the first data, from among a plurality of pieces of data arranged in the first storage or the different storage.

7. The storage control device according to claim 1, wherein
the control of relocation selects the first data in accordance with an input or output load from among a plurality of pieces of data arranged in the first storage or the different storage.

8. The storage control device according to claim 7, wherein
the control of relocation selects, as the first data, data whose input or output load is higher than a prescribed value from among a plurality of pieces of data arranged in the first storage or the different storage in a case when performance of the first storage is higher than performance of the different storage.

9. The storage control device according to claim 7, wherein
the control of relocation selects, as the first data, data whose input or output load is lower than a prescribed value from among the plurality of pieces of data in a case when performance of the first storage is lower than performance of the different storage.

10. The storage control device according to claim 1, wherein
the control of relocation selects data as the first data in accordance with a number of internal retries, from among a plurality of pieces of data.

11. The storage control device according to claim 1, wherein
the control of relocation selects, as the first data, data that has not been mirrored, from among a plurality of pieces of data.

12. The storage control device according to claim 1, wherein
the control of relocation relocates the first divisional data to a same storage when the movement control unit conducts movement control consecutively, and distributedly arranges the first divisional data in a different storage when the movement control unit does not conduct consecutive movement control.

13. A storage system comprising:
a first storage;
a second storage to be replaced with the first storage; and
at least one different storage that is different from the first or second storage, wherein
the second storage includes a processor that executes a process comprising:
conducting, on the basis of information related to distributed arrangement in a case when first divisional data obtained by dividing first data has been arranged distributedly in the first storage and in the different storage, control of relocating the first divisional data to the first storage from the different storage; and
conducting control of moving the first data stored in the first storage from the first storage to the second storage after moving a control unit from the first storage to the second storage, the control unit being configured to conduct input or output control of the first data.

14. A non-transitory computer-readable recording medium having stored therein a program for causing a computer to execute a process comprising:
conducting, on the basis of information related to distributed arrangement in a case when a first divisional data obtained by dividing first data has been arranged distributedly in a first storage and in at least one different storage different from the first storage, control of relocating the first divisional data to the first storage from the different storage; and
conducting control of moving the first data stored in the first storage from the first storage to a second storage after moving a control unit to the second storage, the control unit being configured to conduct input or output control of the first data.
